(19) United States
(12) Patent Application Publication
(10) Pub. No.: US 2014/0278643 A1
(43) Pub. Date: Sep. 18, 2014

(54) SYSTEM AND METHOD FOR REDUCING CUSTOMER NOISE IN A FACILITIES MANAGEMENT COMPUTING ENVIRONMENT

(71) Applicant: FIRST SERVICE NETWORKS INC., Linthicum, MD (US)

(72) Inventors: Clyde MOORE, Paradise Valley, AZ (US); Michael FERREIRA, Fountain Hills, AZ (US)

(73) Assignee: FIRST SERVICE NETWORKS INC., Linthicum, MD (US)

(21) Appl. No.: 13/843,606

(22) Filed: Mar. 15, 2013

(51) Int. Cl. G06Q 10/06

(52) U.S. Cl. CPC G06Q 10/063114
USPC 705/7.15

(57) ABSTRACT

Methods and systems are provided for reducing customer noise a facilities management computing environment. The method includes creating an electronic service request record (SRR) in response to a job request; placing the SRR in a first electronic queue if an estimated time of arrival (ETA) is not communicated to the customer within a first time period t1; entering a time of arrival into the SSR after the ETA is communicated to the customer; placing the SRR in a second electronic queue if the job is not completed within an SLA time period t2; entering a time of completion into the SRR after the job is completed; placing the SRR in a third electronic queue if a customer survey is not completed within a survey time period t3; and closing the SRR after completion of the customer survey.

### TECHNICAL FIELD

The present invention generally relates to computer systems and applications for facilities management, and more particularly to a distributed processing system for reducing customer noise.

### BACKGROUND

In the context of the present disclosure, facilities management broadly refers to the coordination of maintenance and repair activities for enterprises having multiple locations such as restaurants, shops, offices, hospitals, and virtually any other type of commercial, industrial, retail, or service site. In a typical scenario, a company specializing in third party facilities management, referred to herein as a facilities manager (FM), is contracted by the owner/operator of the business entity (the customer) to perform scheduled preventive maintenance (PM) services and non-scheduled repair services (also known as a service request or “SR”) for some or all of the customer's locations.

For non-scheduled service requests, the key term in the contractual relationship between the FM and the customer typically involves the time elapsed between initial notification of the problem until the problem is fixed (e.g., 24 or 48 hours depending on the nature of the problem). This metric is often embodied in a service level agreement (SLA) between the FM and the customer. In order to maintain a high level of customer satisfaction, the FM is incented to quickly dispatch a technician upon receipt of a request for service, and to complete the repair in a timely and cost efficient manner.

The FM may operate one or more service centers through which the FM coordinates selecting and assigning a technician to each PM and SR activity. A particular technician, in turn, may be employed by the FM or, alternatively, the FM may contract with a local contracting company to provide on demand service technicians and an inventory of replacement parts. Presently known systems for managing the daily operations of an FM service center include the FUSION™ software system developed for First Service Networks, Inc. of Linthicum, Md., a leader in the field of multi-site maintenance and repair services. Information pertaining to the FUSION™ system may be found at www.firstservicenetworks.com.

The key terms governing the contractual relationship between the FM and the contractor include the technician's hourly rate and the cost for replacement parts used in connection with the maintenance and service activities. In most cases, the technician's hourly rate is agreed to in advance for the term of the contract between the FM and the contractor. Thus, the key variable subject to scrutiny often surrounds the cost of replacement parts. Presently known systems for automatically managing repair and maintenance costs are described in U.S. Pat. No. 7,685,076 B2 entitled “Online Reduction in Repair and Maintenance Costs” issued Mar. 23, 2010 and commonly assigned herewith.

Mature and robust systems have been developed for managing PM and SR work flow initial receipt of the repair request through project completion, and for generating an electronic invoice covering the technician's time and the cost of the replacement parts. These systems, however, are limited in their ability to monitor customer satisfaction during the pendency of a service request, and to identify and quantify customer concerns and complaints which negatively affect customer satisfaction (referred to herein as “customer noise”).

### SUMMARY OF THE INVENTION

In accordance with various embodiments of the present invention, systems and methods are provided for identifying, quantifying, and addressing the key metrics which impact the level of customer satisfaction or dis-satisfaction associated with a facilities maintenance repair function. The invention further provides for feeding back these data in real time (or near real time) into a distributed processing system, and for identifying specific actions to be taken to thereby reduce the measured customer noise.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures, and:

FIG. 1 is a schematic block diagram of a relationship map involving a facilities management company, a contractor, a customer site, and a customer corporate headquarters in accordance with an embodiment;

FIG. 2 is a schematic block diagram of a facilities management computing environment in accordance with an embodiment;

FIG. 3 is a block diagram detailing the work flow for a typical service request, interposed with customer noise metrics in accordance with an embodiment;

FIG. 4 is a flow chart summarizing some of the salient aspects of the work flow diagram of FIG. 3;

FIG. 5 is a schematic block diagram of a control circuit for minimizing customer noise through the use of measured feedback in a facilities management computing environment according to an embodiment;

FIG. 6 is a flow chart illustrating an exemplary method for controlling customer noise through the use of measured feedback in accordance with an embodiment;

FIGS. 7-9 are screenshots of exemplary customer noise queues in accordance with various embodiments;

FIG. 10 is a screenshot of an exemplary customer follow-up survey form in accordance with an embodiment; and

FIG. 11 is an umbrella report in the form of a graph depicting total days open past completion SLA versus time in accordance with an embodiment.

### DETAILED DESCRIPTION OF PREFERRED EXEMPLARY EMBODIMENTS

Embodiments of the subject matter described herein generally relate to systems and methods for identifying, measuring, and/or quantifying customer noise, and providing real time (or near real time) feedback using a distributed processing system to reduce customer noise in a facilities management computing environment.

In various embodiments, the systems and methods described herein may be implemented in computer code stored on or embodied in a computer readable medium such as a hard drive, removable drive, or network server, and the system includes an interactive user interface displayed on a mobile computing device such as a tablet.

Turning now to FIG. 1, a relationship map 100 includes a facilities management company (also referred to as the facilities manager (FM)) 102 including a pool of staff technicians 103, a contractor including contractor technicians 104, a customer site 106, and a customer headquarters (customer HQ) 108. In a typical scenario, a customer 108, such as a restaurant, coffee shop, hospital, office, or any other type of commercial or industrial retail or service business has a plurality of associated customer sites 106 (only one such customer site 106 is shown in FIG. 1 for clarity). Due to the complex nature of facilities management involving the repair and maintenance of plumbing, electrical apparatus, heating, ventilation, and air conditioning (HVAC) systems, and the like, and further due to the geographically dispersed nature of multi-site customer organizations, many customers contract with an FM to coordinate their maintenance and repair functions under a service level agreement (SLA).

When a scheduled preventive maintenance (PM) task or a non-scheduled service request (SR) requires attention, the FM 102 dispatches a service technician to the appropriate customer site 106. In a typical scenario, the manager on duty at the customer site reports an equipment failure or other service request to the FM 102 via an alert communication indicated by broken arrow 110. The alert communication 110 may be in the form of an email, telephone call, text message, or any convenient communication modality.

In response to communication 110, the FM 102 assigns the task to a staff technician if one is available (indicated by arrow 112). If no staff technician is available, FM 102 assigns the task to contractor technician 104 (indicated by arrow 113), advising the staff technician (or contractor technician) of the nature of the problem, the location of the customer site 106, and the expected cost of the service call, expressed as an amount “not to exceed” (NTE). Upon receipt of the SR communication 112 or 113, the staff technician (arrow 115) or contractor technician (arrow 114) is dispatched to the customer site 106.

After the technician repairs the equipment or otherwise completes the work order at the customer site 106, the technician generates an electronic work ticket identifying the component parts replaced at the work site during the repair, and submits an electronic work ticket evidencing completion of the service call to the contractor HQ 104. The contractor 104 then converts the work ticket to an invoice, and submits an electronic invoice to the FM 102 for payment.

Referring now to FIG. 2, an exemplary facilities management computing environment 200 includes a server 202 that supports applications 228 for managing the work flow for SRs and PMs from origination to completion, for rendering electronic invoices, for measuring customer noise, and for using customer noise metrics as feedback to reduce or eliminate customer. The applications 228 are configured to access data relating to work flow, comments from customer service representatives (CSR) who interface with customers, and quality related reports from a dynamic database 230 maintained by FM service center 102.

Data, user interface screens, and report forms and templates utilized by the applications 228 may be provided via a network 245, such as a cloud computing environment, to any number of nodes or devices configured to interact with the network 245. Exemplary nodes may include: i) a tablet computer or other mobile device 240 operated by the technician; ii) a computer (e.g., a desktop computer) 242 located at the contractor HQ; iii) a device 244 (e.g., a mobile or land line telephone, laptop, desktop, or tablet computer) located at the customer site 106 or otherwise used by the manager of the customer site; iv) a computer 246 located at and/or used by customer service representatives, schedulers, supervisors, and administrators associated with the FM 102; and v) a computer 248 located at or otherwise associated with the customer HQ.

The database 230 may be implemented using conventional database server hardware. In various embodiments, the database 230 shares processing hardware with the server 202 including input/output (I/O) hardware 207, a processor 205, and memory 206. In other embodiments, the database 230 may be implemented using separate physical and/or virtual database server hardware that communicates with the server 202 to perform the various functions described herein. In an exemplary embodiment, the database 230 includes a database management system or other equivalent software capable of retrieving and providing defined subsets of the data 132 128 in response to a query initiated or otherwise provided by an application 128, as described in greater detail below.

The server 202 operates with any sort of conventional processing hardware. The input/output features 207 generally represent the interface(s) to networks (e.g., to the network 245, or any other local area, wide area or other network), mass storage, display devices, data entry devices and/or the like.

The processor 205 may be implemented using any suitable operating system 209 or processing system, such as one or more processors, controllers, microprocessors, microcontrollers, processing cores and/or other computing resources spread across any number of distributed or integrated systems, including any number of “cloud-based” or other virtual systems. The memory 206 represents any non-transitory short or long term storage or other computer-readable media capable of storing programming instructions for execution on the processor 205, including any sort of random access memory (RAM), read only memory (ROM), flash memory, magnetic or optical mass storage, and/or the like. The computer-executable programming instructions, when read and executed by the server 202 and/or processor 205, cause the server 202 and/or processor 205 to create, generate, or otherwise facilitate the applications 228 and perform one or more additional tasks, operations, functions, and/or processes described herein. It should be noted that the memory 206 represents one suitable implementation of such computer-readable media, and alternatively or additionally, the server 202 could receive and cooperate with external computer-readable media that is realized as a portable or mobile component or platform, e.g., a portable hard drive, a USB flash drive, an optical disc, or the like.

With continued reference to FIG. 2, the data processing engine 260 performs bulk processing operations on the data 232 such as uploads or downloads, search queries, and the rendering of various forms and templates such as work ticket, electronic invoices, and the like. In exemplary embodiments, the applications 228 may make use of interface features such as user interface screens 222.

The various computing devices that interface with the cloud 245 may employ a conventional browser application to contact the server 202, using a networking protocol such as the hypertext transport protocol (HTTP) or the like. The application 228 may contain Java, ActiveX, or other content that can be presented using conventional client software running on the client device (e.g., tablet 240); other embodiments may simply provide dynamic web or other content that can be presented and viewed by the user, as desired. As described in greater detail below, the data processing engine 260 suitably obtains the requested data 232 from the database 230 as needed to populate the work tickets or other features of the particular application 228.

In accordance with various embodiments, application 228 may be an interactive application including a number of modules for managing work flow for PMs and SRs, and for measuring, quantifying, and mitigating customer noise using real time (or near real time) feedback, as described in more detail below.

FIG. 3 is a block diagram of an exemplary work flow 300 for a typical service request interposed with customer noise metrics. More particularly, work flow 300 illustrates the initial generation of an SR at stage 310. Specifically, an SR is created when a customer alerts the FM that a service problem exists which requires attention, typically through a telephone call 302, an email 304 sent directly from the customer to the FM, or an email 306 configured by the customer using the tools provided at an FM customer portal such as may be found at www.firstservicenetworks.com.

Once an SR is created, work flow 300 requires that an estimated time of arrival (ETA) be documented in the system within a predetermined period of time (e.g., one hour) and, importantly, communicated to the customer. In a preferred embodiment, the customer is notified of the expected arrival time (ETA) of the technician via telephone, which gives the CSR the opportunity to directly and personally interface with the client. The present inventors have found that this initial contact with the customer can be a critical factor in reducing overall customer noise.

With continued reference to FIG. 3, the system alerts the CSR as the one hour deadline approaches, to help ensure that an ETA is entered into the system within the one hour time frame. If the ETA is entered into the system within the hour, then work flow 300 proceeds to stage 312, discussed in greater detail below. If, however, the ETA is not entered within the predetermined window (e.g., one hour), the ETA failure is entered into a first central queue 314 comprising a dynamic compilation of all SRs for which an ETA was not entered into the system within the allotted period of time. All entries on central queue 312 are expedited; however, the SR may not proceed through the work flow unless and until an ETA is documented. In this way, central queue 312 represents one of several real time (or near real time) feedback loops which identify customer noise preemptively, and provides a mechanism to address customer noise at an early stage in the work flow process. The manner in which central queue is processed is discussed in greater detail below.

Once an ETA is entered into the system and/or communicated to the customer, the SR is updated to include the ETA in the SR detail in the system. In addition, if an SR had been previously included on central queue 312 as an ETA failure, the SR is removed from queue 312 and resumes normal work flow processing. Although the present invention requires that an ETA be documented within an hour, the actual ETA may be up to four (4) hours or more after the initial creation of the SR, depending on various factors. In general, the ETA must be within a reasonable window following SR creation, for example in the range of four (4) HOURS.

Once the ETA is entered and the SR is process in the ordinary course, the system then “waits” until the technician arrives at the job site and registers a “time in” notice with the system (stage 316), typically by using a tablet computer to communicate with the FM server. Notably, the system will not allow the technician to “time out” (discussed below) unless and until the technician first times in.

The next customer noise metric which occurs in the work flow 300 surrounds the point at which the technician finishes fixing the equipment or otherwise completes the service call and “times out” (stage 318). More particularly, a typical SLA may include one or more of the following four time-based metrics:
i) mission critical (e.g., 4 hours)
ii) emergency (e.g., 24 hours)
iii) urgent (e.g., 48 hours)
iv) project (up to 15 days).
   That is, the job must be completed within the specified time from the point the initial service request was made. Completing the job within the allotted time is referred to as “within SLA”; not completing the job within the specified time is referred to as “out of SLA”.

If the job is completed within SLA designated time window (e.g., 24 hours), the technician is permitted to “time out” (stage 318), and the work flow processing proceeds in the ordinary course. If, however, the job is not completed within the SLA defined parameter, the SR is placed on a second customer noise reduction queue, namely, central queue 320. Importantly, the technician is not permitted to complete the job unless and until the “time out” field is completed. The manner in which central queue 320 is processed is discussed below.

In connection with timing out (stage 318), the technician interactively (e.g., using his tablet computer) fills out a “job completion” template (stage 322), which renders an electronic work ticket. Once the job is complete, a third customer noise metric is measured and quantified; namely, through the vehicle of a customer satisfaction survey (stage 324). By properly configuring and conducting the survey (discussed below), customer satisfaction/dis-satisfaction may be measured and effectively quantified. Moreover, by requiring that the survey be conducted within a predetermined time window following job completion (e.g., 48 hours), real time (or near real time) feedback is used to reduce what might otherwise be a higher level of customer noise. This is accomplished in accordance with one embodiment by entering the SR into a third queue, namely, central queue 326, if the customer satisfaction survey is not timely undertaken by the CSR. Specifically, the SR cannot undergo further processing following job completion unless and until the survey is conducted.

FIG. 4 is a flow chart summarizing some of the salient aspects of the work flow diagram of FIG. 3. More particularly, a method 400 typically begins with creating or initiating an SR (Task 402) as discussed above in connection with FIG. 3. The method 400 then requires that the ETA be entered into the system within a predetermined window of time (e.g., one hour) (Task 404). If the ETA is documented within the hour, the work flow allows the technician to “time in”; if, on the other hand, the ETA is not documented within an hour, the SR is placed on the first queue 314 until the ETA is communicated to the customer (Task 406).

Method 400 further then proceeds to job completion. More particularly, the system monitors the SR to ensure that the technician times out within the SLA requirement (Task 408). If the job is completed within the SLA window (typically four (4) hours), the technician may “time out”; if the technician does not “time out” within the four hour window, the SR is placed onto the second queue 320 (Task 410) until the technician times out. In the event the job cannot be completed due to exigent circumstances such as the need for a component part not immediately available, the NTE being exceeded thus requiring a new quote, and the like, the system performs sub-status processing, the details of which are beyond the scope of and not required for a proper understanding of this disclosure.

Once the job is completed, the system requires the CSR to complete a customer satisfaction survey within a predetermined window of time such as, for example, 48 hours. If the survey is completed within the allocated time period, the work flow for the SR is finished; if the survey is not timely completed, the SR is placed onto the third queue 326 (Task 412) until the survey is completed. Alternatively, as discussed below, if the CSR attempts to conduct the survey but is unable to due to, for example, customer resistance, unavailability, or unwillingness, the SR work flow may proceed to completion without conducting the survey.

FIG. 5 is a schematic block diagram of a computer implemented control circuit 500 for minimizing customer noise through the use of real time (or near real time) measured feedback. In particular, the control circuit 500 includes a comparator 502 and a processing module 510. A first input (work flow) 504 and a second input (performance metrics) 506 are applied to the comparator 502. The first input 504 generally corresponds to the work flow requirements (e.g., ‘communicate ETA’ stage 312, ‘time out’ stage 318, and ‘survey’ stage 324) described in conjunction with FIGS. 3 and 4; the second input 506 generally corresponds to the performance metrics (e.g., the first, second, and third queues 314, 320, and 326) also discussed above in connection with FIGS. 3 and 4.

The output 508 of the control circuit 500 represents customer noise or customer dis-satisfaction. Customer noise may be identified, measured, and quantified in any number of ways. In the illustrated example, customer noise is measured empirically during the conversation between the customer and the CSR when the ETA is initially communicated, and subsequently when the customer satisfaction survey is conducted. Customer noise is also sampled directly by comparing the time out stage 316 against the applicable SLA constraint.

Processing module 510 represents the processing of queues 314, 320, and 326 by the CSRs, their supervisors, and personnel associated with further escalation of the queues, as necessary. By way of non-limiting example, SRs appearing on a queue are “worked” by contacting the technician, the contractor, the customer, parts suppliers, or anyone else as necessary or appropriate to satisfy the underlying predicate for placing the SR on the queue in the first place. In the straightforward case where an ETA was not communicated to the customer within an hour, the SR may be removed from the queue 314 once the ETA is communicated to the customer. Significantly, by placing the SR on the queue 314, the ETA notification failure places the SR on an escalated status until the ETA communication failure is resolved.

Moreover, while comparator 502 and processing stage 510 are modeled as generic processing components, those skilled in the art will appreciate that the functions carried out by circuit 500 may be implemented by any suitable combination of the computing and processing components described above in connection with, inter alia, FIG. 2.

FIG. 6 is a flow chart illustrating an exemplary method 600 for controlling customer noise through the use of measured feedback as generally shown in FIG. 5. More particularly, method 600 involves inputting work flow requirements (Task 602) and performance metrics (Task 604) into the system, and sampling customer noise at appropriate output points (Task 606). When noise is detected, the system processes the noise (Task 608), and uses the processed noise in a feedback loop, feeding the processed noise back into the system (Task 610). The system continues to sample the noise (Task 612), and the process 600 is continuously repeated to thereby drive customer noise to a minimum level.

FIGS. 7-9 are screenshots of exemplary customer noise queues in accordance with various embodiments. More particularly, FIG. 7 is a screenshot 700 of an exemplary queue 702 (corresponding to queue 314), setting forth the status of SRs for which the ETA was not communicated to the customer within the prescribed time (e.g., 1 hour). FIG. 8 is a screenshot 800 of an exemplary queue 802 (corresponding to queue 320, setting forth the status of SRs in which the job was not completed within the SLA timeframe (e.g., 4 hours). FIG. 9 is a screenshot 900 of an exemplary queue 902 (corresponding to queue 326, setting forth the status of those SRs in which the customer survey was not completed within the predetermined timeframe (e.g., 48 hours).

FIG. 10 is a screenshot of an exemplary customer follow-up survey template 1000 in accordance with an embodiment. More particularly, survey 1000 includes fields 1002 comprising “yes” or “no” type questions, and in the illustrated example are configured to qualify the customer responding to the survey as being competent to do so. Survey 1000 also includes fields 1004 which involve a rating scheme, for example, in the range of 1-10. In the illustrated example, the two key metrics include the time to complete the job (field 1006), and the level of satisfaction with the technician (field 1008). The answers to these questions are pooled together quantified for a large number of SRs, and the information is used to further reduce noise going forward.

FIG. 11 is an exemplary umbrella report in the form of a graph depicting total days in which SRs remain open past the required SLA completion timeframe over any desired period of time, such as calendar months. This tool gives senior management a long term view of a service center's overall performance, and allows additional system changes to be made to further reduce noise. For example, the umbrella report and the survey results may be used to manipulate and fine tune various metrics and implementation details associated with the work flow 300, the nature, content, and number of queues, and processes 400 and 600.

In addition to the umbrella report shown in FIG. 10, various intermediate levels of processing may be employed to further reduce customer noise. In particular, periodic (e.g., daily, hourly) reports are prepared based on the current status of all pending SRs to determine any outliers. That is, in addition to the foregoing queues, the database of SRs is periodically interrogated to identify any SR that may be in an unfavorable status by being out of compliance with any work flow metric. By identifying and processing all non-compliant SRs on a daily or hourly basis, many customer noise issues are addressed before they become a significant problem.

The various processes and systems described herein may be implemented through a distributed computing environment which includes an interactive user interface presented to the technicians, customers, CSRs, managers, supervisors, and administrators on various computers such as lap tops, desk tops, and mobile computing devices such as a tablet computer. The interactive user interface, in turn, includes a series of screenshots which prompt the users to point and click on a touch screen, type in data, and perform various other interactive functions.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

A method is thus provided for reducing customer noise in a facilities management computing environment. The method includes creating an electronic service request record (SRR) in response to a job request from a customer at a customer site; placing the SRR in a first electronic queue if an estimated time of arrival (ETA) is not communicated to the customer within a first time period t₁; entering a time of arrival into the SSR by a technician at the customer site after the ETA is communicated to the customer; placing the SRR in a second electronic queue if the job is not completed within an SLA time period t₂; entering a time of completion into the SRR by the technician at the customer site after the job is completed; placing the SRR in a third electronic queue if a customer survey is not completed within a survey time period t₃; and closing the SRR after completion of the customer survey.

In an embodiment, the method includes processing the first, second, and third electronic queues to reduce customer noise by contacting at least one of the customer and the technician.

In another embodiment, the method includes removing the SRR from the first electronic queue upon entry of the ETA into the SRR, removing the SRR from the second electronic queue upon entering the time of completion into the SRR by the technician at the customer site after the job is completed, and removing the SRR from the third electronic queue upon completion of the customer survey.

In another embodiment, t₁, t₂, and t₃ are measured from the creation of the SRR, t₁ is in the range of one hour, t₂ is in the range of four hours, t₃ is in the range of forty-eight hours, and the ETA is orally communicated to the customer, and the customer survey is conducted orally.

A distributed computer processing system is also provided for use in a facilities management computing environment. The system includes: a server having at least one processor configured to run a customer noise reduction computer program and to receive a first input comprising service request (SR) work flow requirements and a second input comprising performance metrics, and to produce at least one output signal representing customer noise; a web-based user interface; and a customer service representative (CSR) computer connected to the server and configured to display the user interface; wherein the system is configured to sample the customer noise signal and display a first, a second, and a third electronic queue on the CSR computer in response to the sampled customer noise signal.

In an embodiment, the first electronic queue comprises a list of service request records (SRRs) for which an estimated time of arrival (ETA) was not communicated to the customer within a first time period t₁, the second electronic queue comprises a list of service request records (SRRs) for which a job associated with the SRR was not completed within an SLA time period t₂, and the third electronic queue comprises a list of service request records (SRRs) for which a customer survey was not completed within a survey time period t₃.

In another embodiment, the first, second, and third electronic queues are processed by telephone, t₁, t₂, and t₃ are measured from the creation of the SRR, and wherein t₁ is in the range of one hour, t₂ is in the range of four hours, and t₃ is in the range of forty-eight hours.

A computer application embodied in a non-transitory medium is also provided for operation by a one or more computer processors for performing the steps of: creating an electronic service request record (SRR) in response to a job request from a customer at a customer site; placing the SRR in a first electronic queue if an estimated time of arrival (ETA) is not communicated to the customer within a first time period t₁; entering a time of arrival into the SSR by a technician at the customer site after the ETA is communicated to the customer; placing the SRR in a second electronic queue if the job is not completed within an SLA time period t₂; entering a time of completion into the SRR by the technician at the customer site after the job is completed; placing the SRR in a third electronic queue if a customer survey is not completed within a survey time period t₃; and closing the SRR after completion of the customer survey.

In an embodiment, the computer application is further configured to: remove the SRR from the first electronic queue upon entry of the ETA into the SRR; remove the SRR from the second electronic queue upon entering the time of completion into the SRR by the technician at the customer site after the job is completed; and remove the SRR from the third electronic queue upon completion of the customer survey.

Moreover, in another embodiment, t₁, t₂, and t₃ are measured from the creation of the SRR, and t₁ is in the range of one hour, t₂ is in the range of four hours, and t₃ is in the range of forty-eight hours.

In yet another embodiment, the first, second, and third electronic queues are processed by telephone.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method for reducing customer noise in a facilities management computing environment, comprising the steps of:
creating an electronic service request record (SRR) in response to a job request from a customer at a customer site;
placing the SRR in a first electronic queue if an estimated time of arrival (ETA) is not communicated to the customer within a first time period t₁;
entering a time of arrival into the SSR by a technician at the customer site after the ETA is communicated to the customer;
placing the SRR in a second electronic queue if the job is not completed within an SLA time period t₂;
entering a time of completion into the SRR by the technician at the customer site after the job is completed;
placing the SRR in a third electronic queue if a customer survey is not completed within a survey time period t₃; and
closing the SRR after completion of the customer survey.

2. The method of claim 1, further comprises processing the first, second, and third electronic queues to reduce customer noise.

3. The method of claim 2, wherein processing comprises contacting at least one of the customer and the technician.

4. The method of claim 1, further comprising removing the SRR from the first electronic queue upon entry of the ETA into the SRR.

5. The method of claim 4, further comprising removing the SRR from the second electronic queue upon entering the time of completion into the SRR by the technician at the customer site after the job is completed.

6. The method of claim 5, further comprising removing the SRR from the third electronic queue upon completion of the customer survey.

7. The method of claim 1, wherein t₁, t₂, and t₃ are measured from the creation of the SRR.

8. The method of claim 1, wherein t₁ is in the range of one hour, t₂ is in the range of four hours, and t₃ is in the range of forty-eight hours.

9. The method of claim 1, further comprising communicating the ETA to the customer orally, and conducting the customer survey orally.

10. A distributed computer processing system for use in a facilities management computing environment, comprising:
a server having at least one processor configured to run a customer noise reduction computer program and to receive a first input comprising service request (SR) work flow requirements and a second input comprising performance metrics, and to produce at least one output signal representing customer noise;
a web-based user interface; and
a customer service representative (CSR) computer connected to the server and configured to display the user interface;
wherein the system is configured to sample the customer noise signal and display a first, a second, and a third electronic queue on the CSR computer in response to the sampled customer noise signal.

11. The processing system of claim 10, wherein the first electronic queue comprises a list of service request records (SRRs) for which an estimated time of arrival (ETA) was not communicated to the customer within a first time period t₁.

12. The processing system of claim 11, wherein the second electronic queue comprises a list of service request records (SRRs) for which a job associated with the SRR was not completed within an SLA time period t₂.

13. The processing system of claim 12, wherein the third electronic queue comprises a list of service request records (SRRs) for which a customer survey was not completed within a survey time period t₃.

14. The processing system of claim 13, wherein the first, second, and third electronic queues are processed by telephone.

15. The processing system of claim 13, wherein t₁, t₂, and t₃ are measured from the creation of the SRR.

16. The method of claim 13, wherein t₁ is in the range of one hour, t₂ is in the range of four hours, and t₃ is in the range of forty-eight hours.

17. A computer application embodied in a non-transitory medium for operation by a one or more computer processors for performing the steps of:
creating an electronic service request record (SRR) in response to a job request from a customer at a customer site;
placing the SRR in a first electronic queue if an estimated time of arrival (ETA) is not communicated to the customer within a first time period t₁;
entering a time of arrival into the SSR by a technician at the customer site after the ETA is communicated to the customer;
placing the SRR in a second electronic queue if the job is not completed within an SLA time period t₂;
entering a time of completion into the SRR by the technician at the customer site after the job is completed;
placing the SRR in a third electronic queue if a customer survey is not completed within a survey time period t₃; and
closing the SRR after completion of the customer survey.

18. The computer application of claim 17, further configured to:
remove the SRR from the first electronic queue upon entry of the ETA into the SRR;
remove the SRR from the second electronic queue upon entering the time of completion into the SRR by the technician at the customer site after the job is completed; and
remove the SRR from the third electronic queue upon completion of the customer survey.

19. The computer application of claim 18, wherein t₁, t_{2, 3and t3} are measured from the creation of the SRR, and further wherein t₁ is in the range of one hour, t₂ is in the range of four hours, and t₃ is in the range of forty-eight hours.

20. The computer application of claim 19, wherein the first, second, and third electronic queues are processed by telephone.
